(19) United States
(12) Patent Application Publication
(10) Pub. No.: US 2010/0132680 A1
(43) Pub. Date: Jun. 3, 2010

(54) EXHAUST GAS SENSOR HEATER CONTROL APPARATUS

(75) Inventor: Takeshi Iwahashi, Aichi (JP)

Correspondence Address: GIFFORD, KRASS, SPRINKLE,ANDERSON & CITKOWSKI, P.C, PO BOX 7021, TROY, MI, 48007-7021, US

(73) Assignee: TOYOTA JIDOSHA KABUSHIKI KAISHA, AICHI-KEN (JP)

(21) Appl. No.: 12/531,770

(22) PCT Filed: Apr. 28, 2008
(86) PCT No.: PCT/JP2008/058163

§ 371 Date: Sep. 17, 2009

(30) Foreign Application Priority Data
May 18, 2007 (JP) 2007-132470

(51) Int. Cl. F02D 41/00

(52) U.S. Cl. 123/697

(57) ABSTRACT

In one embodiment of an engine (1) in which air-fuel ratio feedback control is performed based on output of an exhaust gas sensor (100) disposed in an exhaust path, when the engine (1) starts in an extremely low temperature state (e.g., −20 to −30° C.), a heater (200) that heats a sensor element (110) of the exhaust gas sensor (100) is not powered immediately after the engine (1) starts, rather, power to the heater (200) is started when an engine coolant water temperature has reached a temperature near an air-fuel ratio feedback control starting water temperature.

### TECHNICAL FIELD

The present invention relates to an exhaust gas sensor heater control apparatus that controls powering to a heater that heats an exhaust gas sensor disposed in an exhaust path of an internal combustion engine.

### BACKGROUND ART

In an internal combustion engine (below, also referred to as an engine) mounted in a vehicle, ordinarily, harmful components (such as HC, CO, and NOx) included in exhaust gas are purified using a catalyst disposed in an exhaust path of the engine. The purification by this catalyst is most effective when the mixture is burned at a theoretical air-fuel ratio.

The oxygen concentration in the exhaust gas is detected using an exhaust gas sensor disposed in the exhaust path of the engine, and feedback control of the fuel injection amount is performed such that an actual air-fuel ratio obtained from the detected oxygen concentration matches a target air-fuel ratio (theoretical air-fuel ratio).

As exhaust gas sensors that employ such air-fuel ratio feedback control, air-fuel ratio sensors and oxygen sensors are known that have a structure in which a sensor element is configured with, for example, an atmosphere-side electrode (e.g., a platinum electrode), an exhaust-side electrode (e.g., a platinum electrode), and a dispersion/resistance layer provided on a solid electrolyte layer (e.g., partially stabilized zirconia), the atmosphere-side electrode of this sensor element being freed to the atmosphere, and the exhaust-side electrode being put in contact with exhaust gas in the exhaust path. The air-fuel ratio sensor is a sensor whose output values change linearly according to the air-fuel ratio of exhaust gas from the engine. The oxygen sensor is a sensor whose output values change in steps near the theoretical air-fuel ratio.

With an exhaust gas sensor such as an air-fuel ratio sensor, it is necessary to keep the sensor element in an active state in order to maintain detection accuracy. Therefore, a heater (electric heater) that heats the sensor element is provided, and power to the heater is controlled such that the element temperature becomes a predetermined activation temperature. Power control using duty ratio control, in which the amount of heat emitted by the heater is controlled by changing the ratio (duty ratio) of power time and non-power time of the heater, is ordinarily adopted for control of power to the heater. In such heater power control, conventionally, the heater of the exhaust gas sensor is turned on and heating of the sensor element is started at the same time as starting of the engine.

In the heater control of the exhaust gas sensor, warm-up control that prevents sudden boiling breakage of the sensor element is also performed.

Sudden boiling breakage of the sensor element is a phenomenon in which during engine stoppage or the like, part of the water vapor in the atmosphere condenses and liquefies and attaches to the sensor element, and the moisture of the attached droplets suddenly boils due to sudden heating (heating with 100% duty ratio power) of the sensor element, and the sensor element is broken by a shock due to the sudden boiling of that moisture. In order to prevent such sudden boiling breakage of the sensor element, power to the heater is executed at a low duty ratio (e.g., 5 to 15%), and warm-up control is performed in which moisture is caused to evaporate slowly, such that droplets of moisture attached to the sensor element do not suddenly boil.

With this sort of sensor element warm-up control, conventionally, the power duty ratio and the warm-up time (time from turning on the heater until starting power at 100% duty ratio) when warming up are adapted, using the coolant water temperature when the engine starts as a parameter. The coolant water temperature is detected when the engine starts, and the power duty ratio and warm-up time when warming up are determined according to the detected coolant water temperature.

Patent Document 1: JP 2000-304721A

Patent Document 2: JP 2004-69644A

Patent Document 3: JP 2005-214662A

### DISCLOSURE OF INVENTION

### Problems to be Solved by the Invention

Incidentally, in an engine in which air-fuel ratio feedback control is executed, in a case where the engine starts in an extremely low temperature state (approximately −20 to −30° C.), when the engine coolant water temperature is in a low temperature range (for example, 0° C. or less), without performing air-fuel ratio feedback control based on output of the exhaust gas sensor, an air-fuel ratio slightly rich control is performed that increases the fuel injection amount to set a slightly rich air-fuel ratio. In this case, when the engine coolant water temperature reaches an air-fuel ratio feedback control starting water temperature (for example, 0° C.), the air-fuel ratio slightly rich control is stopped, and air-fuel ratio feedback control based on the output of the exhaust gas sensor is started. Even in such a case of starting at an extremely low temperature, with a conventional heater control, the heater of the exhaust gas sensor is turned on and heating of the sensor element is started at the same time as starting the engine.

Here, when the engine has been started in an extremely low temperature state, the time until the sensor element of the exhaust gas sensor reaches the activation temperature is short (e.g., about 10 to 25 seconds) relative to the time until the engine coolant water temperature reaches the air-fuel ratio feedback control starting water temperature (e.g., about 4 to 5 minutes). Therefore, the sensor element of the exhaust gas sensor activates at an early stage prior to the time when the engine coolant water temperature reaches the air-fuel ratio feedback control starting water temperature. When sensor element activation is thus completed prior to starting the air-fuel ratio feedback control, excess power (time of power to the heater) for maintaining the element temperature of the sensor element in the time from sensor element activation completion to starting of air-fuel ratio feedback control is necessary, and that power consumption is wasteful.

Also, when heating of the sensor element of the exhaust gas sensor is started at the same time as starting the engine in an extremely low temperature state, in a state in which the engine coolant water temperature is low and much condensed water is included in the exhaust gas, the sensor element may be heated to a high temperature (e.g., several hundred degrees C.). In such a circumstance, there is a risk that breakage of the sensor element (water breakage) will occur due to thermal shock caused by moisture affixing to the surface of the sensor element in a high temperature state.

It is an object of the present invention to provide an exhaust gas sensor heater control apparatus that, in an internal combustion engine in which an air-fuel ratio feedback control is performed based on the output of an exhaust gas sensor disposed in an exhaust path, activation of a sensor element of the exhaust gas sensor can be completed in coordination with the time when the air-fuel ratio feedback control is started, so that it is possible to reduce wasteful power consumption when starting the internal combustion engine at an extremely low temperature, or the like.

### Means for Solving the Problems

The present invention presumes an exhaust gas sensor heater control apparatus that, in an internal combustion engine in which air-fuel ratio feedback control is performed based on output of an exhaust gas sensor disposed in an exhaust path, controls powering to a heater that heats a sensor element of the exhaust gas sensor. This sort of heater control apparatus is provided with a water temperature detector (water temperature detecting means) that detects a coolant water temperature of the internal combustion engine; and a power controller (power control means) that does not power the heater in a case where the coolant water temperature when the internal combustion engine starts is lower than {air-fuel ratio feedback control starting water temperature−predetermined value}, and starts power to the heater when the coolant water temperature has reached {air-fuel ratio feedback control starting water temperature−predetermined value}.

In the present invention, it is preferable that the predetermined value that is set for the air-fuel ratio feedback control starting water temperature (the determination value used to determine the start of power to the heater), in consideration of the time until the element temperature of the sensor element of the exhaust gas sensor reaches an activation temperature from near the air-fuel ratio feedback control starting water temperature, is set to a value such that activation of the sensor element is completed in coordination with the time when the coolant water temperature of the internal combustion engine reaches the air-fuel ratio feedback control starting water temperature. The predetermined value (power start determination value) is about 5 to 10° C., for example.

According to the present invention, when the internal combustion engine starts in an extremely low temperature state (e.g., about −20 to −30° C.), the heater is not powered immediately after the internal combustion engine starts, rather, power to the heater is started when the coolant water temperature of the internal combustion engine has reached {air-fuel ratio feedback control starting water temperature−predetermined value}, i.e., has reached a temperature near the air-fuel ratio feedback control starting water temperature, and so it is possible for activation of the sensor element of the exhaust gas sensor to be completed in coordination with the time when the air-fuel ratio feedback control is started. Thus, it is possible to shorten the time from completion of sensor element activation to starting of air-fuel ratio feedback control, and therefore it is possible to reduce wasteful power consumption due to unnecessarily powering the heater.

Moreover, by starting power to the heater when the coolant water temperature of the internal combustion engine has reached a temperature near the air-fuel ratio feedback control starting water temperature, in comparison to starting heating of the sensor element of the exhaust gas sensor at the same time that the engine starts in an extremely low temperature state, the sensor element is heated to a high temperature in a state in which there is little condensed water in the exhaust gas, so it is possible to suppress water breakage of the sensor element due to moisture attaching to the element.

In the present invention, the predetermined value (power start determination value) that is set for the air-fuel ratio feedback control starting water temperature may be a fixed value.

The predetermined value (power start determination value) that is set for the air-fuel ratio feedback control starting water temperature may be determined according to the coolant water temperature when the internal combustion engine starts, or alternatively, may be determined according to the coolant water temperature and the cumulative intake air amount when the internal combustion engine starts.

By determining the predetermined value that is set for the air-fuel ratio feedback control starting water temperature, i.e., the coolant water temperature at which power to the heater is started, according to the engine operating state in this way, it is possible to precisely coordinate the time when activation of the sensor element of the exhaust gas sensor is completed with the time when the air-fuel ratio feedback control is started.

Here, in the exhaust gas sensor heater control, as described above, warm-up control that prevents sudden boiling breakage of the sensor element of the exhaust gas sensor is performed. The power duty ratio and warm-up time during this warm-up control are adapted using the coolant water temperature when the engine starts as a parameter. When, as in the present invention, the heater is not powered immediately after the internal combustion engine starts, rather, power to the heater is started when the coolant water temperature of the internal combustion engine has reached a temperature near the air-fuel ratio feedback control starting water temperature, there is a possibility that due to the warm-up control that prevents sudden boiling breakage, the start of air-fuel ratio feedback control will be delayed.

For example, in the heater control of the present invention, when the internal combustion engine has started at an extremely low temperature, heater power is started (heater ON) after passage of some amount of time (the time until the coolant water temperature reaches a temperature near the air-fuel ratio feedback control temperature) since the internal combustion engine started. Therefore, during the time until heater power starts, depending on the operating state of the internal combustion engine, there may be instances when the element temperature of the sensor element of the exhaust gas sensor increases, so that the element temperature when starting power to the heater is high relative to the coolant water temperature when the internal combustion engine starts. In such a circumstance, when warm-up control is performed based on the power duty ratio and warm-up time regulated by the coolant water temperature when the internal combustion engine starts, warm-up control is continued even though the element temperature has increased above the dew point, and due to that excessive warm-up control the start of air-fuel ratio feedback control is delayed.

Consequently, in the present invention, when controlling warm-up of the sensor element prior to applying full power to the heater, a warm-up time necessary for warming up the sensor element is calculated based on the temperature (element temperature) of the sensor element itself, not the coolant water temperature when the internal combustion engine starts, and powering to the heater is controlled based on that warm-up time. By performing heater control using the actual element temperature of the sensor element in this way, it is possible to suppress continuation of wasteful warm-up control, and thus start the air-fuel ratio feedback control at an appropriate time.

Also, in the present invention, when powering the heater, full power to the heater is started without warming up the sensor element when the element temperature of the sensor element has reached a value set in consideration of the dew point. By immediately starting full power when there is no possibility that sudden boiling breakage will occur in the sensor element, it is possible to prevent the execution of wasteful warm-up control, and thus the air-fuel ratio feedback control can be started at an appropriate time.

In the present invention, examples of specific methods for obtaining the element temperature of the sensor element of the exhaust sensor include a method in which admittance or impedance of the sensor element is detected, and the element temperature is estimated from that detected value, and a method in which the element temperature of the sensor element is estimated from the cumulative intake air amount (cumulative value of the exhaust gas temperature) of the internal combustion engine.

### Effects of the Invention

According to the present invention, in an internal combustion engine in which an air-fuel ratio feedback control is performed based on the output of an exhaust gas sensor disposed in an exhaust path, when the internal combustion engine starts in an extremely low temperature state, the heater is not powered immediately after starting the internal combustion engine, rather, heater power is started when the coolant water temperature of the internal combustion engine has reached a temperature near the air-fuel ratio feedback control starting water temperature, so it is possible to shorten the time from completion of sensor element activation to starting of air-fuel ratio feedback control, and therefore it is possible to reduce wasteful power consumption due to unnecessarily powering the heater.

### BRIEF DESCRIPTION OF DRAWINGS

FIG. 1 is a schematic configuration diagram that shows an example of an engine in which the present invention is applied.

FIG. 2 is a cross-sectional view that schematically shows an example of an exhaust gas sensor.

FIG. 3 is a block diagram that shows the configuration of a detection circuit and a heater control circuit that are incorporated into an ECU.

FIG. 4 is a flowchart that shows an example of a heater control routine performed when starting the engine.

FIG. 5 shows a power duty ratio of a heater.

FIG. 6 shows an example of a map used to obtain a warm-up time.

FIG. 7 shows an example of a map used to obtain a power start determination value [symbol] that is set for an air-fuel ratio feedback control starting water temperature.

FIG. 8 shows another example of a map used to obtain the power start determination value [symbol] that is set for the air-fuel ratio feedback control starting water temperature.

FIG. 9 is a cross-sectional view that schematically shows another example of an exhaust gas sensor.

FIG. 10 shows temperature properties of a sensor element of an exhaust gas sensor.

### DESCRIPTION OF REFERENCE NUMERALS

1 Engine
2 Injector
8 Three-way catalyst
11 Intake path
12 Exhaust path
21 Water temperature sensor
22 Airflow meter
101 Air-fuel ratio sensor (exhaust gas sensor)
102 Oxygen sensor (exhaust gas sensor)
110 Sensor element
111 Solid electrolyte layer
112 Atmosphere-side electrode
113 Exhaust-side electrode
120 Detection circuit
200 Heater
210 Heater control circuit
300 ECU

### BEST MODE FOR CARRYING OUT THE INVENTION

Following is a description of embodiments of the present invention based on the drawings.

First is a description of an engine (internal combustion engine) in which the invention is applied.

### —Engine—

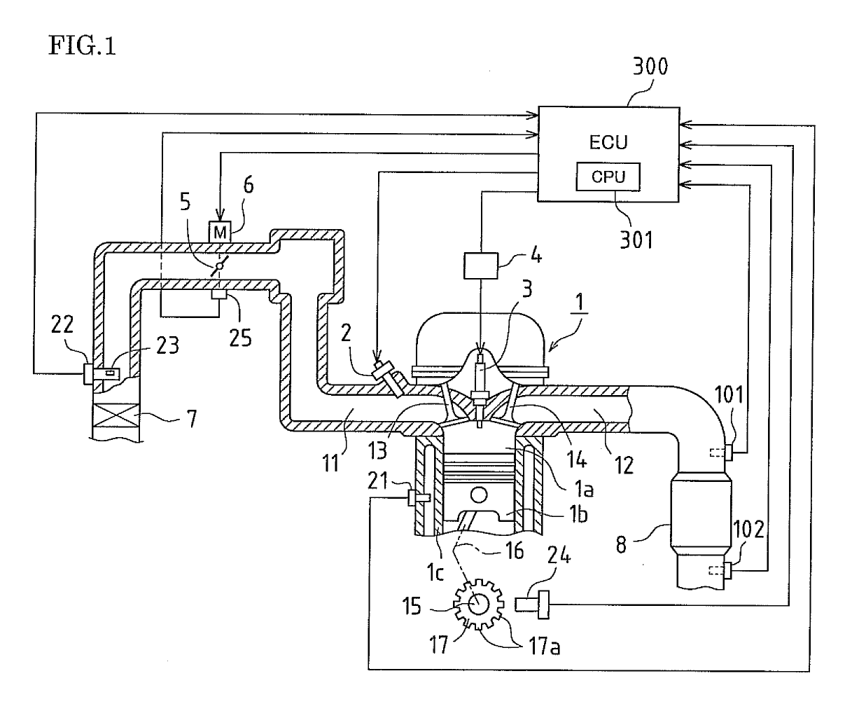

FIG. 1 is a schematic configuration diagram that shows an example of an engine 1 in which the present invention is applied. Note that only the configuration of one cylinder of the engine 1 is shown in FIG. 1.

The engine 1 in this example is, for example, a four cylinder gasoline engine, and is provided with a piston 1b that forms a combustion chamber 1a and a crank shaft 15 that is an output shaft. The piston 1b is connected to the crank shaft 15 via a connecting rod 16, and back-and-forth movement of the piston 1b is converted to rotation of the crank shaft 15 by the connecting rod 16.

A signal rotor 17 that has a plurality of protrusions (teeth) 17a on its outer circumferential face is attached to the crank shaft 15. A crank position sensor (engine revolutions sensor) 24 is provided near the side of the signal rotor 17. The crank position sensor 24 is an electromagnetic pickup, for example, and emits a pulse signal (output pulse) that corresponds to the protrusions 17a of the signal rotor 17 when the crank shaft 15 rotates.

A water temperature sensor 21 that detects a coolant water temperature Thwa of the engine 1 is disposed in a cylinder block 1c of the engine 1.

An ignition plug 3 is disposed in the combustion chamber 1a of the engine 1. Ignition timing of the ignition plug 3 is adjusted by an igniter 4. The igniter 4 is controlled by an ECU (Electronically Controlled Unit) 300.

An intake path 11 and an exhaust path 12 are connected to the combustion chamber 1a of the engine 1. An intake valve 13 is provided between the intake path 11 and the combustion chamber 1a, and the intake path 11 and the combustion chamber 1a are put in communication with each other or are blocked from each other by driving the intake valve 13 to open or close. An exhaust valve 14 is provided between the exhaust path 12 and the combustion chamber 1a, and the exhaust path 12 and the combustion chamber 1a are put in communication with each other or are blocked from each other by driving the exhaust valve 14 to open or close. The intake valve 13 and the exhaust valve 14 are driven to open or close by respective rotation of an intake cam shaft and an exhaust cam shaft to which rotation of the crank shaft 15 is transmitted.

An air cleaner 7, a heated airflow meter 22 that detects an intake air amount, an intake temperature sensor 23 (built into the airflow meter 22), and an electronically controlled throttle valve 5 that adjusts the intake air amount of the engine 1 are disposed in the intake path 11. The throttle valve 5 is driven by a throttle motor 6. The opening degree of the throttle valve 5 is detected by a throttle opening degree sensor 25.

A three-way catalyst 8 is disposed in the exhaust path 12 of the engine 1. An air-fuel ratio sensor 101 is disposed in the exhaust path 12 on the upstream side of the three-way catalyst 8. The air-fuel ratio sensor 101 is a sensor that indicates linear properties for the air-fuel ratio. An oxygen sensor 102 is disposed in the exhaust path 12 on the downstream side of the three-way catalyst 8. The oxygen sensor 102 is a sensor whose output values change in steps near a theoretical air-fuel ratio, and indicates so-called Z properties. The air-fuel ratio sensor 101 and the oxygen sensor 102 will be described in detail below. Below, the air-fuel ratio sensor 101 and the oxygen sensor 102 may also be collectively referred to as an “exhaust gas sensor 100”.

An injector 2 for fuel injection is disposed in the intake path 11. Fuel at a predetermined pressure is supplied to the injector 2 from a fuel tank by a fuel pump, and the fuel is injected into the intake path 11. This injected fuel is mixed with intake air to become a mixture and then is introduced to the combustion chamber 1a of the engine 1. The mixture (fuel+air) introduced to the combustion chamber 1a is ignited by the ignition plug 3 and burns/explodes. Due to burning/explosion of the mixture within the combustion chamber 1a, the piston 1b moves back-and forth and so the crank shaft 15 rotates. The state of the above operation of the engine 1 is controlled by the ECU 300.

### —Air-Fuel Ratio Sensor and Oxygen Sensor—

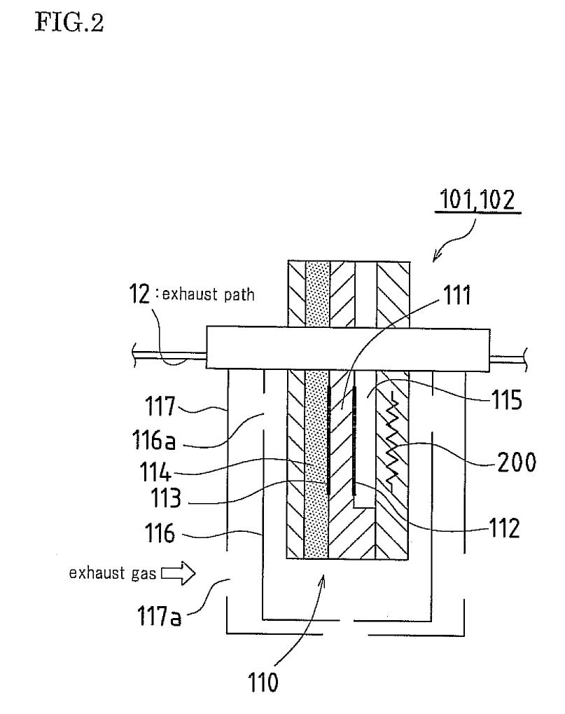

The structure of the air-fuel ratio sensor 101 and the oxygen sensor 102 will be described with reference to FIG. 2. The air-fuel ratio sensor 101 and the oxygen sensor 102 used in this example have basically the same structure.

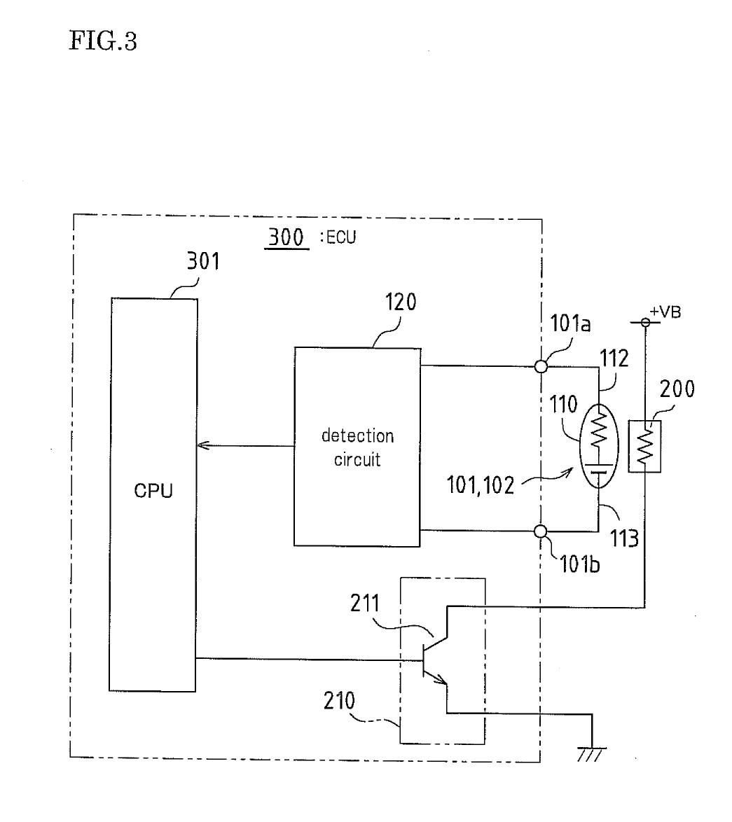

The air-fuel ratio sensor 101 (or oxygen sensor 102) shown in FIG. 2 is a stacked sensor that outputs a signal according to the oxygen concentration in exhaust gas, and is provided with a sensor element 110, a ventilated inner cover 116, and an outer cover 117. Also, a heater 200 is incorporated into the air-fuel ratio sensor 101 (or oxygen sensor 102). The heater 200 is configured with a wire heating element that emits heat when powered from a battery power source VB (see FIG. 3) installed in the vehicle, and heats the entire sensor element 110 with the heat emitted from that heating element.

The sensor element 110 is configured with a plate-like solid electrolyte layer (e.g., made of partially stabilized zirconia) 111, an atmosphere-side electrode (platinum electrode) 112 formed on one face of the solid electrolyte layer 111, an exhaust-side electrode (platinum electrode) 113 formed on the other face of the solid electrolyte layer 111, a dispersion/resistance layer (e.g., a porous ceramic) 114, and so forth.

The atmosphere-side electrode 112 of the sensor element 110 is disposed within an atmosphere duct 115. The inside of the atmosphere duct 115 is open to the atmosphere, and atmosphere that flows into the atmosphere duct 115 makes contact with the atmosphere-side electrode 112.

The surface of the exhaust-side electrode 113 is covered by the dispersion/resistance layer 114, and part of the exhaust gas that flows through the exhaust path 12, in a state dispersed by the dispersion/resistance layer 114, makes contact with the exhaust-side electrode 113. The exhaust gas passes through a small hole 117a of the outer cover 117 and a small hole 116a of the inner cover 116 to arrive at the sensor element 110 (exhaust-side electrode 113).

In the air-fuel ratio sensor 101 having the above structure, an air-fuel ratio detection voltage is applied between the atmosphere-side electrode 112 and the exhaust-side electrode 113, and due to application of this voltage, a current (sensor) flows in the air-fuel ratio sensor 101 according to the oxygen concentration in the exhaust gas. Increase/reduction of this sensor current corresponds to increase/reduction of the air-fuel ratio (degree of leanness/richness), so that the sensor current increases as the air-fuel ratio of the exhaust gas becomes more lean, and the sensor current decreases as the air-fuel ratio becomes more rich. The sensor current that flows in the air-fuel ratio sensor 101 is detected by a detection circuit 120 described below.

In the oxygen sensor 102 having the above structure, when a difference occurs between the oxygen partial pressure of the atmosphere inside of the sensor element 110 and the outside exhaust gas, the oxygen of the side with the higher oxygen partial pressure (normally the atmosphere side) is ionized and passes through the solid electrolyte layer 111 to move to the side with the lower oxygen partial pressure (normally the exhaust side). In the course of ionization, the oxygen molecules receive electrons from the atmosphere-side electrode 112, and in the course of returning to molecules from the ionized state, electrons are released to the exhaust-side electrode 113. Such movement of oxygen molecules is accompanied by movement of electrons from the exhaust-side electrode 113 to the atmosphere-side electrode 112, and as a result, electromotive force occurs between the atmosphere-side electrode 112 and the exhaust-side electrode 113. It is possible to determine whether the air-fuel ratio is rich or lean from the size of this electromotive force (sensor output voltage). The output voltage of the oxygen sensor 102 is detected by the detection circuit 120 described below.

### —ECU—

The ECU 300 is provided with a CPU 301, a ROM, a RAM, a backup RAM, and so forth. In the ROM, various control programs, maps that are referred to when executing those various control programs, and the like are stored. The CPU 301 executes computational processes based on the various control programs and maps stored in the ROM. The RAM is a memory that temporarily stores data resulting from computation with the CPU 301 or data that has been input from the respective sensors, and the backup RAM is a nonvolatile memory that stores that data or the like to be saved when the engine 1 is stopped.

As shown in FIG. 1, various sensors such as the water temperature sensor 21, the airflow meter 22, the intake temperature sensor 23, the crank position sensor 24, the throttle opening degree sensor 25, the air-fuel ratio sensor 101, and the oxygen sensor 102 are connected to the ECU 300. Also, the injector 2, the igniter 4 of the ignition plug 3, the throttle motor 6 of the throttle valve 5, and so forth are connected to the ECU 300.

Furthermore, as shown in FIG. 3, the detection circuit 120 and a heater control circuit 210 are incorporated into the ECU 300. A detection circuit 120 and a heater control circuit 210 are provided for each of the air-fuel ratio sensor 101 and the oxygen sensor 102.

The detection circuit 120 detects the respective output signals (the sensor current that flows in the sensor element 110 in the case of the air-fuel ratio sensor 101, and output current in the case of the oxygen sensor 102) of the air-fuel ratio sensor 101 and the oxygen sensor 102, and outputs the detected output signals to the CPU 301. Also, when the detection circuit 120 detects admittance, described below, the detection circuit 120 applies an admittance detection voltage between the atmosphere-side electrode 112 and the exhaust-side electrode 113 in each of the air-fuel ratio sensor 101 and the oxygen sensor 102, and detects the current that flows in the sensor element 110 due to application of this voltage and outputs the detected current to the CPU 301. The detection circuit 120 applied to the air-fuel ratio sensor 101 also has a function of applying the above air-fuel ratio detection voltage to the air-fuel ratio sensor 101.

The heater control circuit 210 is configured with a transistor 211. A base of the transistor 211 is connected to the CPU 301, and duty control of power to the heater 200 is performed by switching the transistor 211 on/off according to a heater control signal from the CPU 301.

The ECU 300 executes various control of the engine 1 based on detection signals of the various sensors described above.

For example, the ECU 300 executes main air-fuel ratio feedback control based on output of the air-fuel ratio sensor 101 disposed in the exhaust path 12 (on the upstream side of the three-way catalyst 8) of the engine 1. Also, the ECU 300 executes sub air-fuel ratio feedback control based on output of the oxygen sensor 102 disposed in the exhaust path 12 (on the downstream side of the three-way catalyst 8) of the engine 1.

In the main air-fuel ratio feedback control, the amount of fuel that is injected into the intake path 11 from the injector 2 is controlled so that the air-fuel ratio of the exhaust gas that flows into the three-way catalyst 8 matches a control target air-fuel ratio. In the sub air-fuel ratio feedback control, the content of the main air-fuel ratio feedback control is corrected such that the air-fuel ratio of the exhaust gas that flows out downstream of the three-way catalyst 8 becomes a theoretical air-fuel ratio. More specifically, the content of the main air-fuel ratio feedback control is corrected such that the output of the oxygen sensor 102 disposed on the downstream side of the three-way catalyst 8 becomes stoichiometric output. By executing these air-fuel ratio feedback controls, it is possible to precisely maintain the air-fuel ratio on the downstream side of the three-way catalyst 8 at a value near the theoretical air-fuel ratio, and so it is possible to realize excellent emission properties.

Furthermore, the ECU 300 executes “element temperature estimation” and “heater control when starting the engine”, described below.

### —Element Temperature Estimation—

First, as shown in FIG. 10, there is a correlation between the element temperature and admittance of the sensor element 110 of the exhaust gas sensor 100. Using these temperature properties, admittance is detected by a method described below, and the element temperature is estimated based on the detected admittance. The element temperature of the sensor element 110 may also be estimated from a cumulative value of the intake air amount calculated from the output signal of the airflow meter 22 (cumulative value of exhaust gas temperature).

### Detection of Admittance

An admittance detection voltage V is applied between the atmosphere-side electrode 112 and the exhaust-side electrode 113 of the sensor element 110 of the exhaust gas sensor 100, and a current I that flows in the sensor element 110 due to application of this voltage V is detected. A relationship of {V=(1/admittance)×I} [symbol] {admittance=I/V} is established between the applied voltage V and the current I that flows in the sensor element 110, so admittance can be detected (calculated) based on this relationship.

### —Heater Control When Starting the Engine—

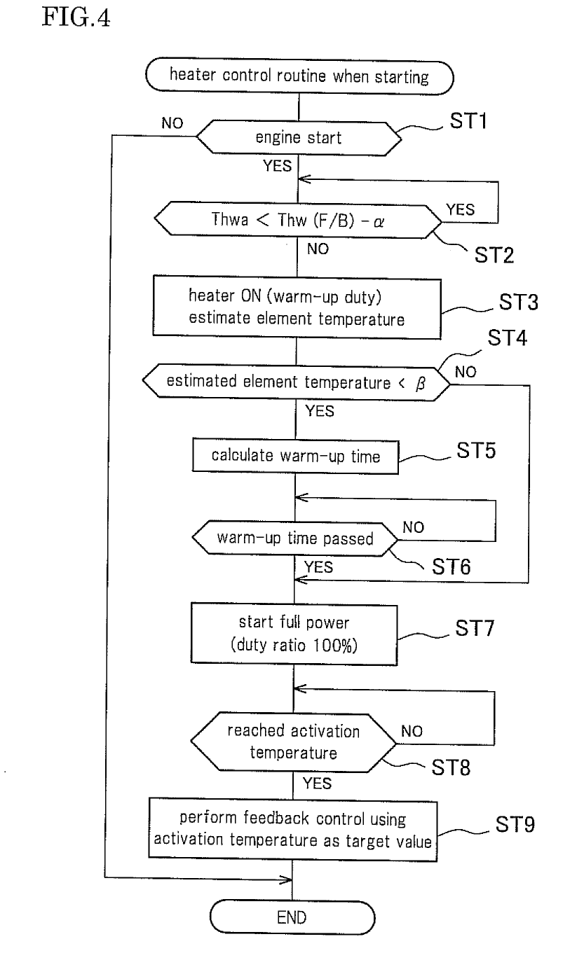

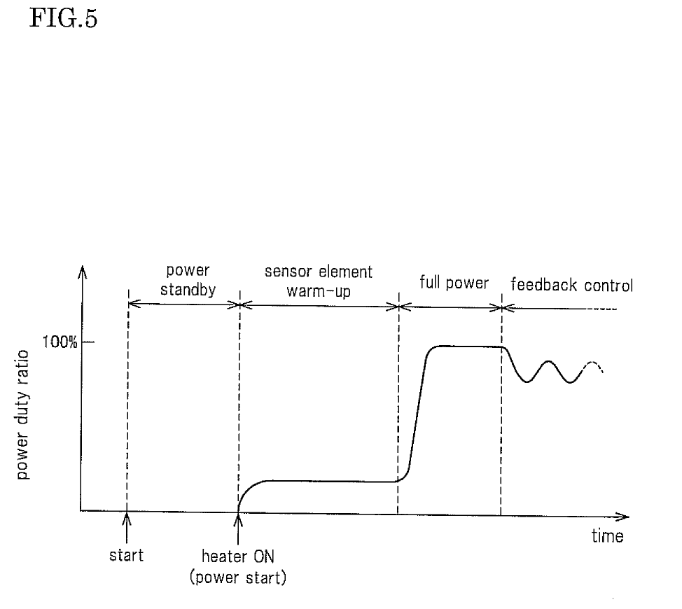

A specific example of heater control when starting the engine will be described with reference to FIGS. 4 and 5. The heater control routine when starting shown in FIG. 4 is executed by the ECU 300.

In Step ST1, a determination is made of whether or not the engine 1 has started, and when the result of that determination is negative (when the engine 1 has not started), the routine is ended. When the result of the determination in Step ST1 is affirmative (when the engine 1 has started), the routine proceeds to Step ST2.

In Step ST2, the coolant water temperature Thwa of the engine 1 is read from the output signal of the water temperature sensor 21, and a determination is made of whether or not that coolant water temperature Thwa is less than {air-fuel ratio feedback control starting water temperature Thw(F/B)− [symbol] (power start determination value)}. When the result of that determination is affirmative (Thwa<Thw(F/B)− [symbol] ), as shown in FIG. 5, the heater 200 is not powered when starting the engine 1 (power standby).

Here, the air-fuel ratio feedback control starting water temperature Thw(F/B) and the power start determination value [symbol] {° C.} used for the determination process in Step ST2 will be described.

First, in this example, the air-fuel ratio feedback control starting water temperature Thw(F/B) is set to 0° C. The power start determination value [symbol] is set to a value such that activation of the sensor element 110 is completed in coordination with the time when the coolant water temperature Thwa of the engine 1 reaches the air-fuel ratio feedback control starting water temperature Thw(F/B).

Specifically, for example, an increase rate {° C./sec} of the coolant water temperature Thwa near the air-fuel ratio feedback control starting water temperature Thw(F/B), and an attainment time {sec} until the element temperature of the sensor element 110 of the exhaust gas sensor 100 reaches the activation temperature from near the air-fuel ratio feedback control starting water temperature Thw(F/B), are obtained through testing, calculation, and so forth in advance, and based on the increase rate {° C./sec} of the coolant water temperature Thwa and the activation temperature attainment time {sec}, the temperature (coolant water temperature Thwa) at which heating (heater ON) of the sensor element 110 should be started in order for activation of the sensor element 110 to be completed in coordination with the time when the coolant water temperature Thwa of the engine 1 reaches the air-fuel ratio feedback control starting water temperature Thw(F/B) is experimentally obtained, and the power start determination value [symbol] {° C.} is set based on the results of that experimentation.

In this example the power start determination value [symbol] is set to 5° C. (fixed value), and as described above the air-fuel ratio feedback control starting water temperature Thw(F/B) is set to 0° C. Accordingly, when the engine 1 has started in an extremely low temperature state (e.g., −20° C.), {Thwa<Thw(F/B)− [symbol] }, so the heater 200 is in a power standby state until the coolant water temperature Thwa of the engine 1 reaches −5° C. (see FIG. 5). Note that when the water temperature when the engine 1 starts is comparatively high (e.g., when the water temperature is 0° C. or more), {Thwa≧Thw(F/B)− [symbol] } so the routine proceeds to Step ST3 immediately after the engine 1 starts.

Next, after the engine 1 starts, the coolant water temperature Thwa of the engine 1 increases, and when the coolant water temperature Thwa has reached {Thw(F/B)− [symbol] } (when the result of the determination in Step ST2 becomes affirmative), in Step ST3 power to the heater 200 is started (heater ON). At this time, the power duty ratio of the heater 200 is set to, for example, 5 to 15% (for warm-up control).

At the same time that power to the heater 200 is started (heater ON), the element temperature of the sensor element 110 of the exhaust gas sensor 100 is estimated. For example, admittance of the sensor element 110 is detected by the above processing, and the element temperature of the sensor element 110 is estimated based on that admittance. Also, the element temperature of the sensor element 110 may be estimated from the cumulative value of the intake air amount (cumulative value of the exhaust gas temperature) calculated from the output signal of the airflow meter 22.

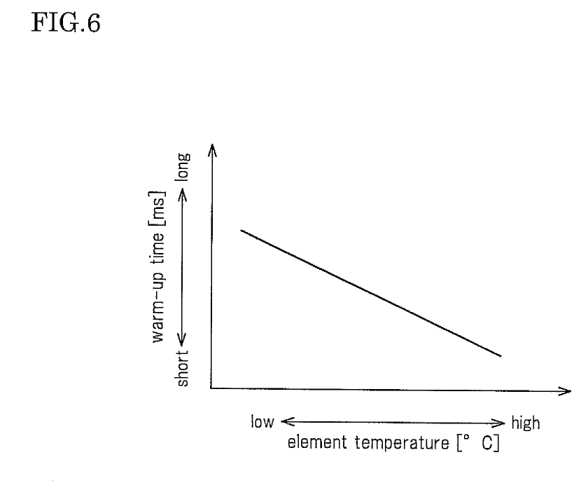

In Step ST4, a determination is made of whether or not the element temperature estimated in Step ST3 is less than a set value [symbol] , and when the result of that determination is affirmative (estimated element temperature< [symbol] ), in Step ST5, a warm-up time (time from heater ON until starting full power) for performing warm-up control that prevents sudden boiling breakage of the sensor element 110 is calculated. Specifically, a warm-up time {ms} is calculated based on the element temperature of the sensor element 110 estimated in Step ST3, with reference to the map in FIG. 6. Note that in the map shown in FIG. 6, a shorter warm-up time {ms} is set as the element temperature increases.

Here, the set value [symbol] used in the determination processing of Step ST4 is set to a temperature in consideration of the dew point (e.g., 60 to 70° C.). Also, in the map (FIG. 6) used to calculate the warm-up time, using the element temperature of the sensor element 110 and the amount of heat emitted by the heater 200 (power duty ratio 5 to 15%), the time until moisture attached to the sensor element 110 sufficiently evaporates is experimentally obtained through testing, calculation, and so forth and converted to a map, and this map is stored in the ROM of the ECU 300.

Next, in Step ST6, a determination is made of whether or not the warm-up time has passed after starting power to the heater, and when the result of that determination becomes affirmative, the power duty ratio of the heater 200 is set to 100% to start full power to the heater 200 (Step ST7).

On the other hand, when the result of the determination in Step ST4 is negative (when the estimated element temperature≧ [symbol] ), there is judged to be no possibility of sudden boiling breakage occurring in the sensor element 110, so without executing warm-up control, full power (power duty ratio 100%) is started immediately after starting power to the heater 200 (Step ST7).

Full power to the heater 200 continues until the element temperature of the sensor element 110 of the exhaust gas sensor 100 reaches the activation temperature, and when the element temperature of the sensor element 110 reaches the activation temperature (when the result of a determination in Step ST8 becomes affirmative), feedback control of the power duty ratio of the heater 200 is performed such that the element temperature of the sensor element 110 matches a target value (activation temperature) (see FIG. 5).

As described above, with the heater control when starting of this example, when the engine 1 starts in an extremely low temperature state (e.g., −20° to −30° C.), power to the heater 200 is not started immediately after the engine 1 starts, rather, power to the heater 200 starts when the coolant water temperature Thwa of the engine 1 has reached a temperature near the air-fuel ratio feedback control starting water temperature Thw(F/B) (the air-fuel ratio feedback control starting water temperature Thw(F/B)−5° C.), so it is possible to shorten the time from completion of activation of the sensor element 110 until the air-fuel ratio feedback control is started, and therefore it is possible to reduce wasteful power consumption due to powering the heater.

Moreover, because power to the heater 200 is started with the coolant water temperature Thwa of the engine 1 at a temperature near the air-fuel ratio feedback control starting water temperature Thw(F/B), in comparison to a case of starting power to the heater 200 (starting to heat the sensor element 110) when in an extremely low temperature state, the sensor element 110 is heated to a high temperature in a state in which there is little condensed water in the exhaust gas, so it is possible to suppress water breakage of the sensor element 110 due to moisture attaching to the element.

Also, with the heater control when starting of this example, the element temperature of the sensor element 110 is estimated when starting power (when warming up) to the heater 200, and the warm-up time necessary for warming up the sensor element 110 is calculated based on that estimated element temperature, so it is possible to suppress continuing of wasteful warm-up control, and therefore possible to start the air-fuel ratio feedback control at an appropriate time. Furthermore, when starting power to the heater 200, full power to the heater 200 is started without warming up the sensor element 110 when the element temperature of the sensor element 110 has reached the set value [symbol] set in consideration of the dew point, so in this case as well, it is possible to prevent the execution of wasteful warm-up control, and therefore possible to start the air-fuel ratio feedback control at an appropriate time.

### OTHER EMBODIMENTS

In the above example, a fixed value is used as the power start determination value [symbol] used to determine the start of power to the heater 200 (the power start determination value [symbol] set for the air-fuel ratio feedback control starting water temperature), but this is not a limitation; the power start determination value [symbol] may also change according to the operating state of the engine 1.

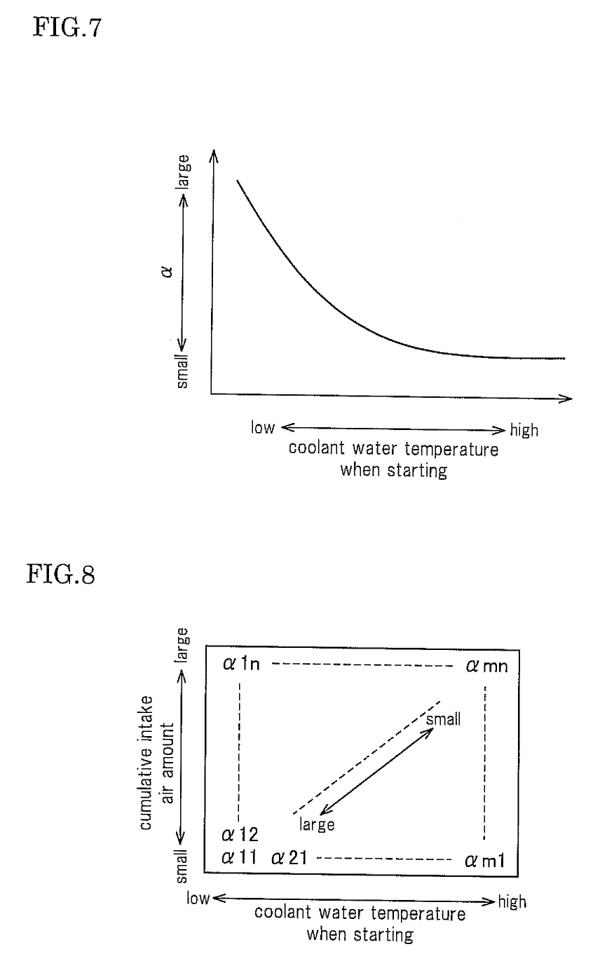

For example, as shown in FIG. 7, the relationship between the coolant water temperature when the engine 1 starts and the power start determination value [symbol] may be obtained through testing, calculation, and so forth in advance and converted to a map, and the power start determination value [symbol] calculated based on the coolant water temperature Thwa read when the engine 1 starts, with reference to the map shown in FIG. 7.

Also, as shown in FIG. 8, the relationship between the coolant water temperature when the engine 1 starts and the cumulative intake air amount and power start determination value [symbol] may be obtained through testing, calculation, and so forth in advance and converted to a map, and the power start determination value [symbol] calculated based on the coolant water temperature Thwa read when the engine 1 starts, with reference to the map shown in FIG. 8.

In the above example, the element temperature is estimated by detecting admittance of the sensor element 110 of the exhaust gas sensor 100, but this is not a limitation of the invention; impedance of the sensor element 110 may be detected and the element temperature of the sensor element 110 estimated from that impedance, and the warm-up time necessary for warming up the sensor element 110 calculated based on that estimated element temperature. Alternatively, the element temperature of the sensor element 110 may be estimated from the cumulative intake air amount (cumulative value of the exhaust gas temperature) of the engine 1, and the warm-up time necessary for warming up the sensor element 110 calculated based on that estimated element temperature.

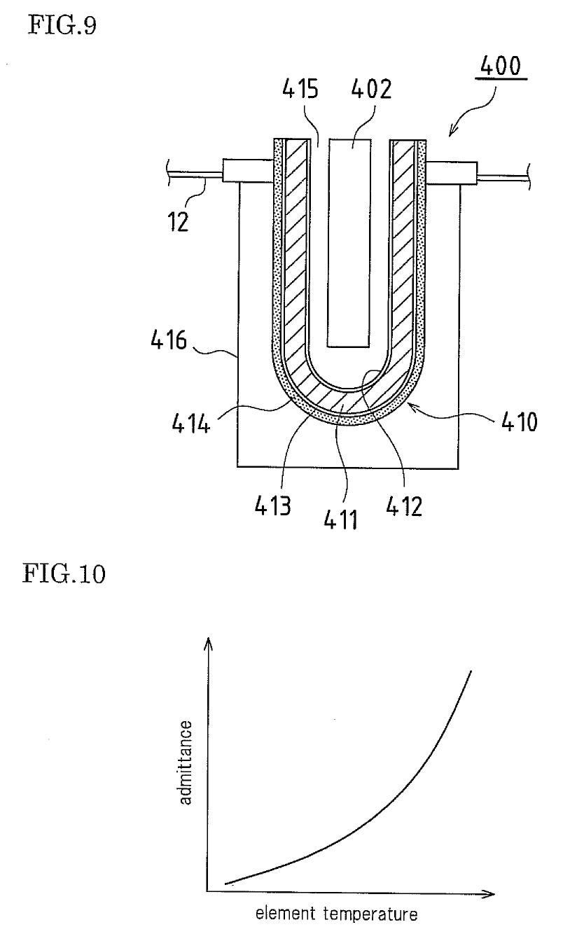

Above, an example is described in which the control apparatus of the invention is applied to a stacked exhaust gas sensor (air-fuel ratio sensor/oxygen sensor), but this is not a limitation of the invention. The invention is also applicable to a cup-shaped exhaust gas sensor. An example of a cup-shaped exhaust gas sensor is shown in FIG. 9.

An exhaust gas sensor 400 shown in FIG. 9 is provided with a sensor element 410 and a cover 416. A hole (not shown) for introducing exhaust gas into the exhaust gas sensor 400 is provided in the cover 416. The sensor element 410 is disposed inside of the cover 416.

The sensor element 410 has a tube-like (cup-like) structure in which one end is closed. The sensor element 410 is configured with a solid electrolyte layer (e.g., made of partially stabilized zirconia) 411, an atmosphere-side electrode (e.g., a platinum electrode) 412 formed on an inside face of the solid electrolyte layer 411, an exhaust-side electrode (e.g., a platinum electrode) 413 formed on an outside face of the solid electrolyte layer 411, and a porous protective layer (e.g., a porous ceramic) 414, and so forth.

An atmosphere chamber 415 open to the atmosphere is formed inside of the sensor element 410. Atmosphere that flows into the atmosphere chamber 415 makes contact with the atmosphere-side electrode 412. A heater 402 for heating the sensor element 410 is disposed in the atmosphere chamber 415. The surface of the exhaust-side electrode 413 is covered by the porous protective layer 414, and part of the exhaust gas that flows through the exhaust path 12 makes contact with the exhaust-side electrode 413 via the porous protective layer 414.

In the exhaust gas sensor 400 of this example as well, the output signal changes according to the oxygen concentration of the exhaust gas, and it is possible to determine whether the air-fuel ratio is rich or lean from the size of this output signal.

Above, an example is described in which the heater control of the invention is applied to an engine in which an air-fuel ratio sensor and an oxygen sensor are disposed in an exhaust path, but this is not a limitation; the heater control of the invention may be applied to an engine in which only an oxygen sensor is disposed in the exhaust path.

Above, an example is described in which the invention is applied to control of a heater of an exhaust gas sensor installed in a four-cylinder gasoline engine, but this is not a limitation; the invention is also applicable to control of a heater of an exhaust gas sensor installed in a multi-cylinder engine having another discretionary number of cylinders, such as a six-cylinder gasoline engine, for example.

The invention is also applicable to control of a heater of an exhaust gas sensor installed in a V-type multi-cylinder gasoline engine or an in-line multi-cylinder gasoline engine.

The invention is not limited to a port injection gasoline engine, and is also applicable to control of a heater of an exhaust gas sensor installed in an in-cylinder direct injection gasoline engine. Further, the invention is not limited to a gasoline engine, and is also applicable to control of a heater of an exhaust gas sensor installed in a diesel engine.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

This application claims priority on Japanese Patent Application No. 2007-132470 filed in Japan on May 18, 2007, the entire contents of which are herein incorporated by reference. Furthermore, the entire contents of references cited in the present description are herein specifically incorporated by reference.

1. (canceled)

2. An exhaust gas sensor heater control apparatus that, in an internal combustion engine in which air-fuel ratio feedback control is performed based on output of an exhaust gas sensor disposed in an exhaust path, controls powering to a heater that heats a sensor element of the exhaust gas sensor, the exhaust gas sensor heater control apparatus comprising:
a water temperature detector that detects a coolant water temperature of the internal combustion engine; and
a power controller that does not power the heater in a case where the coolant water temperature when the internal combustion engine starts is lower than {air-fuel ratio feedback control starting water temperature−predetermined value}, and starts power to the heater when the coolant water temperature has reached {air-fuel ratio feedback control starting water temperature−predetermined value};
the predetermined value that is set for the air-fuel ratio feedback control starting water temperature is determined according to the coolant water temperature when the internal combustion engine starts.

3. The exhaust gas sensor heater control apparatus according to claim 2,
wherein the predetermined value that is set for the air-fuel ratio feedback control starting water temperature is determined according to the coolant water temperature and a cumulative intake air amount when the internal combustion engine starts.

4. The exhaust gas sensor heater control apparatus according to claim 2,
wherein when warming up the sensor element prior to applying full power to the heater, a warm-up time necessary for warming up the sensor element is calculated based on an element temperature of the sensor element, and powering to the heater is controlled based on that warm-up time.

5. The exhaust gas sensor heater control apparatus according to claim 4,
wherein full power to the heater is started without warming up the sensor element when the element temperature of the sensor element has reached a value set in consideration of the dew point.

6. The exhaust gas sensor heater control apparatus according to claim 4,
wherein admittance or impedance of the sensor element is detected, and the element temperature of the sensor element is estimated from that detected value.

7. The exhaust gas sensor heater control apparatus according to claim 5,
wherein admittance or impedance of the sensor element is detected, and the element temperature of the sensor element is estimated from that detected value.

8. The exhaust gas sensor heater control apparatus according to claim 4,
wherein the element temperature of the sensor element is estimated from the cumulative intake air amount of the internal combustion engine.

9. The exhaust gas sensor heater control apparatus according to claim 5,
wherein the element temperature of the sensor element is estimated from the cumulative intake air amount of the internal combustion engine.
